(19) United States
(12) Patent Application Publication
(10) Pub. No.: US 2003/0001299 A1
(43) Pub. Date: Jan. 2, 2003

(54) Method and apparatus for ultrasonic temperature monitoring

(76) Inventors: Nachappa Gopalsami, Naperville, IL (US); Hual-Te Chien, Naperville, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 09/897,832

(22) Filed: Jun. 29, 2001

(51) Int. Cl. B29C 35/08; B28B 17/00

(52) U.S. Cl. 264/40.1; 264/40.6; 425/135; 425/143; 425/78

(57) ABSTRACT

A non-intrusive method of determining temperature and for controlling the Electroconsolidation process is described which is based on the change with temperature of the velocity of sound as it passes through a material. Ultrasonic transducers located outside of the die, but positioned to transmit and receive an ultrasonic signal, are used to determine an average temperature in the line of sight of the transmitted signal. A single-loop feedback system may be used to control the temperature based upon a comparison of the measured temperature to the desired temperature.

### BACKGROUND OF THE INVENTION

This application relates to a non-intrusive method and apparatus for measuring the temperature during Electroconsolidation processes, and more particularly to such a non-intrusive method and apparatus that employs ultrasound to determine the temperature.

The Electroconsolidation process is a method of rapid, pressure-assisted densification of preformed materials (a “preform”). (“Electroconsolidation” is a registered trademark of the Superior Graphite Co., the assignee of the present application.) It is one of several densification methods (referred to as a “soft-tooling” or “pseudoisostatic” process) that utilize particulate solids as pressure transmitting media. It differs from the other processes of this type in that the preformed part is heated by electrical resistive heating of the granular pressure transmitting medium while the medium is in contact with the preform inside the die chamber.

In the Electroconsolidation process, the part to be densified is immersed within a bed of free-flowing, electrically conductive granular medium contained in a cylindrical die chamber. Rams acting on the medium apply pressure mechanically. Heating to the consolidation temperature is achieved by passing an electric current through the medium, causing it to be electrothermally heated. Heat transfers from the medium to the part while the part is subjected to the applied compaction pressure.

The Electroconsolidation process is effective for rapid consolidation of a variety of materials, including powder metals, intermetallics, oxide and non-oxide ceramics, monoliths and composites, and various carbon and graphite composites. It is a candidate whenever pressure is required to achieve high density, as in making reinforced composites, or when applying pressure enables higher or comparable density to be achieved in less time and/or at lower temperature. See U.S. Pat. Nos. 5,348,694, 5,294,382 and 5,246,638, all of which are assigned to the Superior Graphite Co., and which are incorporated herein by reference.

The Electroconsolidation process can be used for near net shape densification of complex shaped parts, which distinguishes the method from hot pressing. The parts to be consolidated do not require cladding, as is needed for hot isostatic pressing. Therefore, the Electroconsolidation process offers simplification and lower costs for production of large quantities of smaller, complex-shaped parts made directly to near-net shape. (

The pressure-transmitting medium for the Electroconsolidation process must be free flowing so that it fills all voids and compresses uniformly against the contour of the part. The medium should also be chemically inert, stable at high temperatures, electrically conductive, and yet have adequate electrical resistivity to act as the resistive heating element in the circuit. It should further be resiliently compressible to allow compaction at high pressure without breakage and to release cleanly from the consolidated part when the pressure is relieved. Graphitic carbons with a high degree of internal porosity are a preferred media for this process. A spheroidal form of porous graphitic carbon (75 μm-500 μm) is particularly suited for this application.

A feature that distinguishes Electroconsolidation processes from other methods is the “inside out” form of heating that occurs within the die by direct resistance heating of the pressure transmitting medium. This enables extremely rapid heating and processing temperatures well in excess of 2500° C. The temperature capability obtainable with the Electroconsolidation process is higher than that for other pressure-assisted densification processes.

Commercial use of the Electroconsolidation process requires effective means to determine and control the temperature variation that is inherent with rapid resistive heating. Temperature sensors or thermocouples placed within the die chamber are not practical in normal production because of their intrusive nature and unsuitability for use in temperatures above 2000° C.

The velocity of sound whether in a solid, liquid, or gas, varies with temperature in a predictable manner. It increases with temperature in gases, but decreases with temperature in most solids and liquids. Based on this property, high-temperature thermometric measurements have been made in hostile environments, such as combustion furnaces. Ultrasonic time-domain reflectometers, for example, use a thin rod with one or more notches along its length. The temperature between the notches, or between a notch and the end of the rod, can be inferred by measuring the round-trip travel time of sound in the notched segment with a pulse-echo method. Although high temperatures can be measured this way using appropriate sensor material, the approach still suffers because it is intrusive, like thermocouples.

Accordingly, it is the principal object of the present invention to provide a non-intrusive method and apparatus for measuring and controlling the temperature attained in Electroconsolidation processes.

### SUMMARY OF THE INVENTION

This object, as well as others that will become apparent with reference to the following description and accompanying drawings, is provided by a non-intrusive method of determining temperature and for controlling the Electroconsolidation process that is based on the change with temperature of the velocity of sound as it passes through a material. Ultrasonic transducers located outside of the die, but positioned to transmit and receive an ultrasonic signal, are used to determine an average temperature in the line of sight of the transmitted signal.

### BRIEF DESCRIPTION OF THE DRAWINGS

FIG. 1 is a schematic diagram of an Electroconsolidation apparatus for use in conjunction with the present invention.

FIG. 2 is a schematic diagram of an Electroconsolidation apparatus showing the position of the pitch-catch transducer assembly used in performing the present invention.

FIG. 3 is a schematic diagram of the ultrasonic pitch-catch sensor electronics.

FIG. 4 is a plot of the velocity of sound versus pressure in the apparatus of the present invention.

FIG. 5 is a plot of the velocity of sound versus temperature calibration curve for the apparatus of the present invention.

FIG. 6 is a plot of the velocity of sound versus temperature for four different pressures and two different heating rates.

FIG. 7 is a plot of the velocity of sound versus temperature giving a quadratic calibration curve derived from two of the tests plotted in FIG. 6.

FIG. 8 is a plot of temperature versus time at constant pressure with the applied electrical current being varied up to a maximum of 10,000 A.

FIG. 9 is a plot of ultrasonically-predicted temperature versus ram thermocouple temperature for two different experiments of similar heating rate.

FIG. 10 is a schematic diagram of a temperature control system in accordance with the present invention.

### DETAILED DESCRIPTION

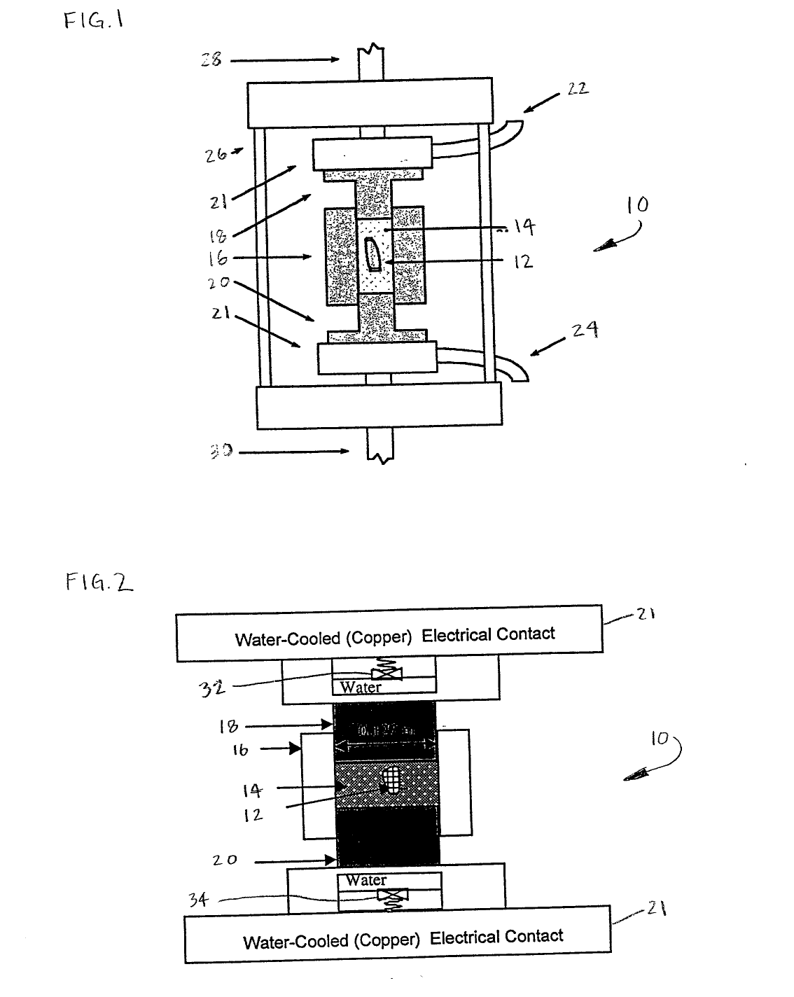

A basic apparatus for performing Electroconsolidation (“EC”) processes, generally designated 10, is shown schematically in FIG. 1. A preform 12 surrounded by a graphite bed pressure-transmitting medium 14 is contained within a cylindrical die chamber 16. Upper and lower rams, 18, 20 respectively, enter the die from both the top and bottom to apply pressure uniaxially. The rams 18, 20 are connected to low-resistance, water cooled electrically conducting blocks 21 connected by electrical leads 22, 24 to a power source (not shown) to enable current to be passed through the pressure transmitting medium 14. The die chamber 16 and upper and lower rams 18, 20 are supported within a post and platen press 26 that has two hydraulic rods 28, 30, through which compressive force is transmitted through the upper and lower rams 18, 20 to the pressure-transmitting medium 14 and the preform 12.

In accordance with the present invention, an ultrasonic pitch-catch technique has been developed for nonintrusive measurement of the temperature of the pressure-transmitting medium in the Electroconsolidation process. With reference to FIG. 2, the transmitting and receiving transducers 32, 34 are placed outside the Electroconsolidation process die in the water cooled blocks 21 (preferably made of copper) where the graphite rams 18, 20 contact the copper. Ultrasonic waves are transmitted and received along the axial direction through the graphite bed 14 in which the material consolidation takes place. Because the sensor measures the average velocity of sound (and thus temperature) along the line of sight between the transducers, temperature changes during heating can be monitored and controlled. It is also possible to use multiple pairs of transducers to monitor temperature profile radially in the die, with various of the pairs being outwardly spaced from the central axis of the die.

The change in the velocity of sound with temperature can be used to determine the temperature within the Electroconsolidation process die 16 during operation. The VOS through the granular graphite is determined by measuring the travel time between the transmitted and received pulses and taking into account the travel times through the transducer blocks and graphite rams.

The transmitting and receiving transducers 32, 34 are located outside the process die 16, and thus do not interfere with the process. Measuring the transit time of pulsed ultrasound along the line of sight between the transducers and knowing the path lengths, the velocity of sound in the powder bed of the die can be calculated. Because sound velocity in a particulate medium is a function of both pressure and temperature, the approach of the present invention is to measure the velocity of sound in the graphite bed as a function of temperature at different pressures and heating rates, and to then correlate the ultrasound data with temperature under certain operating conditions.

Factors that govern the operation of the ultrasonic sensor include transducer temperature, coupling between interfaces, and wave propagation characteristics in the particulate medium. The temperature at the transducer face must stay below its design limit, which is typically around 130-150° C., even though the internal temperature in the process can reach up to 3000° C. To protect the transducer from the process heat, the transducer is placed over a circulating water bath within a water-cooled copper block. The transducers are located in the EC apparatus between the water-cooled electrical contact and the graphite rams at the top and bottom of the die, as shown in FIG. 2.

As shown in FIG. 2, the ultrasonic waves must propagate through different sections of materials and encounter several interfaces, starting from the transmitter transducer, continuing through copper, water, copper, solid graphite, graphite powder, solid graphite, copper, water, copper, and ending with the receiver transducer. Although an oil-based couplant is used between the transducer and the water chamber where the temperature is low, the coupling mechanism between the parallel faces of the transducer assembly and the graphite ram, where temperature can be high, is simply pressure. Wave scattering and attenuation occur in the particulate medium; the scattering depends on the wavelength relative to particle size and the attenuation increases with the void spaces between the particles in the graphite bed. Transmitting ultrasonic energy through the graphite bed with adequate signal-to-noise ratio therefore requires the use of either low frequency and/or application of moderate pressure to the bed.

An EC experiment starts with loading the die chamber manually with graphite powder and the preform between the upper and lower rams. This assembly is then placed between water-cooled copper blocks. The hydraulic rods apply the initial pressure. At ambient pressure, the receiver transducer does not pick up any transmitted signal because of excessive attenuation in the particulate bed. As the pressure is increased, the transmitted ultrasonic pulse begins to be received, typically above 500 psi. At approximately 1000 psi, the signal-to-noise level becomes adequate for temperature tests. Pressures of 2000-10,000 psi are generally used and are usually applied at the onset of heating. The pressure can be held constant or ramped up or down during the heating/cooling cycle. Power is applied and the current is adjusted from 1500 to 10,000 A to establish a prescribed heating rate of up to 2000° C. per minute.

Typical operational variables of the EC system are die diameter, ram pressure, heating rate, and hold time. The ultrasonic sensor was tested against various test conditions. To calibrate the sensor, Type C thermocouples were placed at different locations: the center of the bed, within the ram, the outside surface of the die, and on the transducer surface.

FIG. 3 shows schematically the instrumentation used for the ultrasonic pitch-catch data collection. A 500 kHz tone burst signal from a function generator 40 (Wavetek) is amplified by a 40 dB RF power amplifier 42 (EIN) and applied to a 500 kHz, 1 in.-diameter transmitting transducer (not shown) (Panametrics). The signal from an identical receiving transducer is amplified and filtered by a 40 dB preamplifier 44 with a band-pass filter set at 450-550 kHz. The received signal is displayed on a digital oscilloscope 46 (LeCroy) with respect to the trigger signal of the transmitter waveform. Total transit time between the pitch and catch signal is recorded corresponding to the location of the first peak of the received waveform.

The change in velocity of sound in the bed is measured as a function of temperature up to 2000° C. for different pressures and heating rates. An analysis of the test data reveals that the velocity of sound versus temperature fits a quadratic curve and are reproducible among the tests if the pressure and heating rate are held constant or follow fixed trajectories. The accuracy of temperature prediction in the test range shows an uncertainty of 2.2 percent.

The main variable that was monitored was the total time of flight (TOF) of ultrasonic pulses along the line of sight between the two transducer locations shown in FIG. 2. The amplitude of the received pulses was also checked for excessive attenuation of sound in the materials during heating. Tracing the path of ultrasonic waves, the total TOF is mainly constituted by the transit times in the solid graphite rams (typically 5 in. long; two sections) and in the graphite powder bed (typically 4 in. thick). The ultrasonic TOF of the top and bottom rams at ambient temperature were separately measured by using a pulse-echo technique. These times were then subtracted from the total TOF to obtain the TOF in the bed. Knowing the bed height, which is obtained from a pair of position transducers instrumented on the rams, the velocity of sound in the graphite bed is calculated by dividing the bed height by the TOF in the bed.

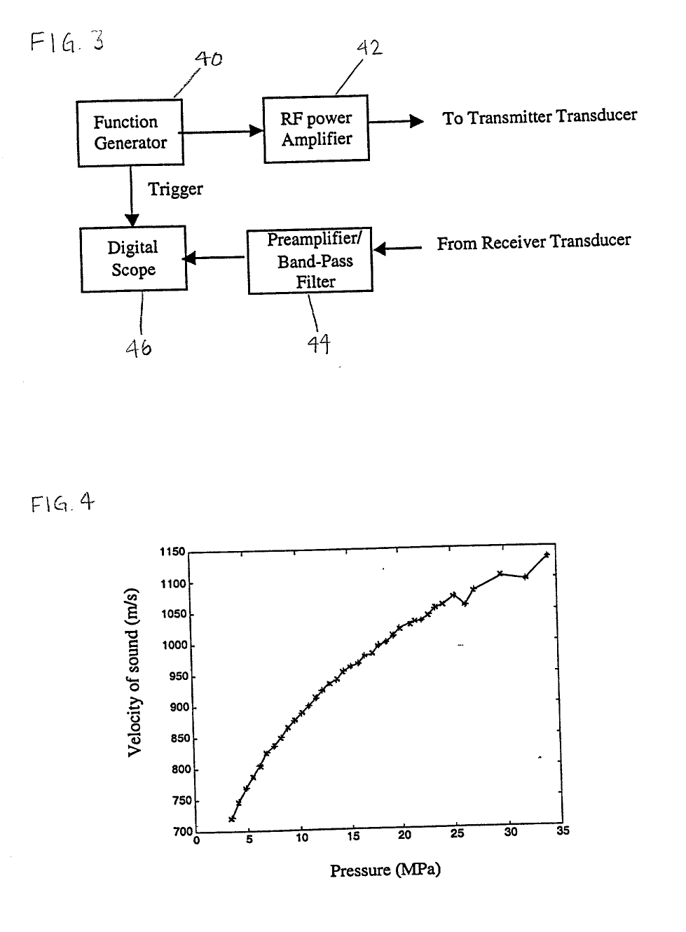

A pressure test was conducted to determine its effect on the velocity of sound in the bed. Because of the powder compaction, the velocity of sound increased with pressure as shown in FIG. 4. Signal height also increased with pressure due to reduced attenuation. This indicates that the pressure must be held constant to determine the effect of temperature on the velocity of sound.

In four experiments with a 3 in. die, the pressure was held constant at 2000 psi and monitored the TOF as heat was increased at a fixed rate of 50° C./min. Three trials of fixed pressure, 17.2 Mpa (2500 psi), and controlled rate of temperature increase and decrease excursions from ambient to 800° C. were done. The VOS vs. Temperature calibration curve derived from these data sets could be fitted to a quadratic equation as shown in FIG. 5. An error analysis of the data with respect to the calibration curve shows a measurement uncertainty of less than 3% or 15° C. With an aim to determine the ultrasonic properties of the bed in these initial experiments, preforms were not used because they could modify the velocity of sound. Also, a fresh batch of graphite powder in each of these experiments was used to eliminate any hysteresis effect. The total TOF showed a steady decrease during heating, and the velocity of sound calculation for the bed showed similar slopes for all cases. However, the starting points, namely the velocity values at ambient temperature, were different among the tests; this may be due to how the particles were initially packed in the bed.

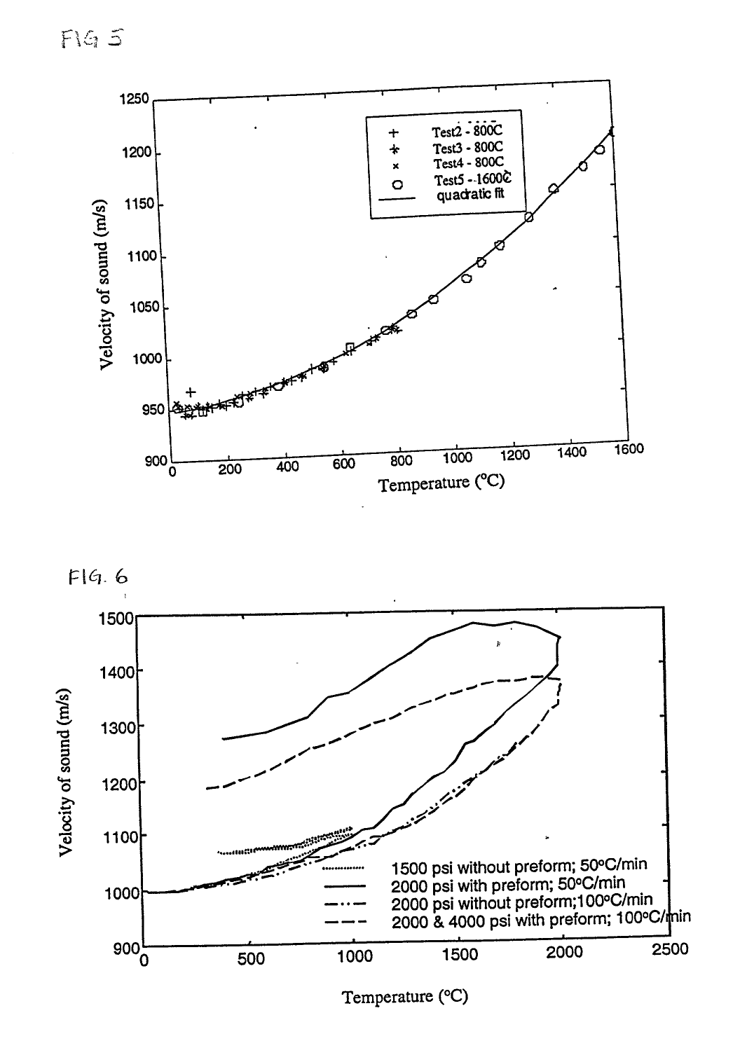

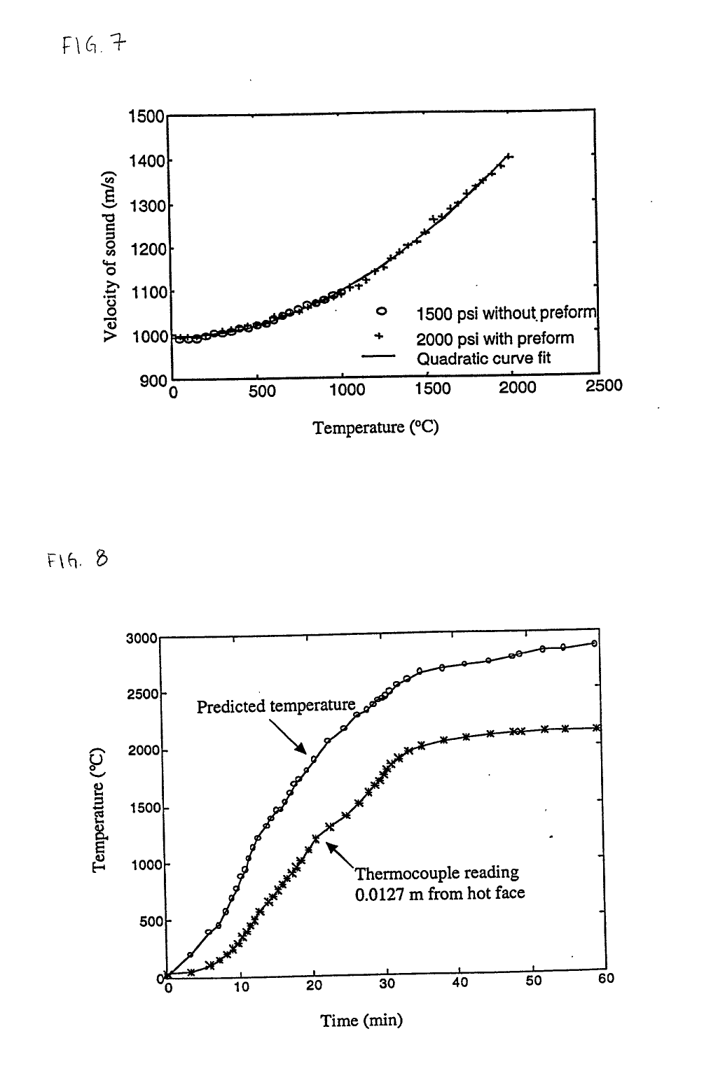

In four further experiments, a 0.127-m die, differing pressures, and two heating rates were used, and the tests were conducted with and without preforms. For the preform, a 90%-dense SiC disk, 0.0254 m in diameter and 0.0048-m thick was used. In one test, a pressure step of 13.79 Mpa up to 850° C. and 27.58 Mpa thereafter, up to 2000° C., was used. Because a step change in pressure introduces a step change in the velocity of sound, the offset between various pressures was corrected with reference to a value that corresponded to 13.79 Mpa. FIG. 6 shows the offset-corrected plots of heating and cooling curves for these tests. Note that the heating curves are grouped according to the heating rate and that the slopes of the 50° C./min heating curves are higher than those of the 100° C./min curves. This change in slope with heating rate appears to be due to the change in the axial temperature profiles with the heating rate and to the sensor's averaging effect. Typically, the temperature peaks at the center of the bed and tapers off on both sides along the axial direction. Because the temperature gradient becomes steeper with the heating rate, a line integral of the temperature would therefore give a lower average value for a faster heating rate.

There is consistently a strong hysteresis between the heating and cooling phase in the first heating-cooling cycle, but as seen in the test corresponding to 10.34 Mpa, this hysteresis nearly disappeared in the second heating-cooling cycle. The hysteresis is attributed to possible powder lockup during thermal expansion, which changes the elastic and relaxation properties of the powder, and also to the various rates of heating and cooling. However, from the process control standpoint, the reproducibility of velocity data during the first heating phase will suffice. FIG. 7 gives a quadratic calibration curve derived from the tests for the 0.127-m die at a 50° C./min heating rate. Error analysis reveals that temperature can be predicted by this method with an uncertainty of <2.2% for temperatures up to 2000° C. in a 0.127-m die.

In two further experiments, attempts were made to take the system to the highest possible temperature by using a 0.0762-m-diameter, 0.0095-m-thick graphite preform in a 0.127-m die. Because the Type C thermocouple that was used will fail to work at these high temperatures, it was placed at a location in the ram where the temperature is lower, by recessing it 0.0127-m from the hot face along the central axis. These tests were nearly identical; keeping the pressure constant at 6.895 Mpa, the applied electrical current was varied to a maximum of 10,000 A and was held there for some time.

The heating trajectory for one of the tests, in terms of thermocouple reading vs. heating time, is shown in FIG. 8. Heating rates as a function of time in these experiments followed a sigmoidal function, with a slow rate in the beginning and end and≈75° C./min in the middle. In principle, to predict temperature from ultrasonic velocity, a calibration curve must be obtained that corresponds to the new heating trajectory. Because independent temperature data inside the bed for this calibration was lacking, the calibration curve that corresponds to a 50° C./min heating rate in FIG. 7 was chosen. This curve is given by the quadratic equation:

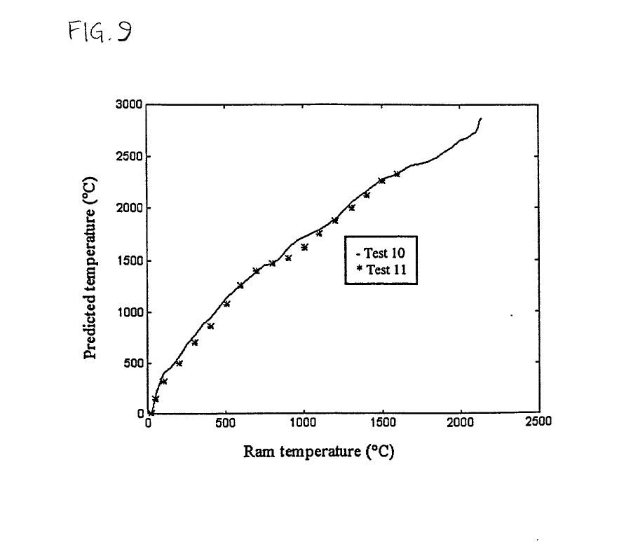

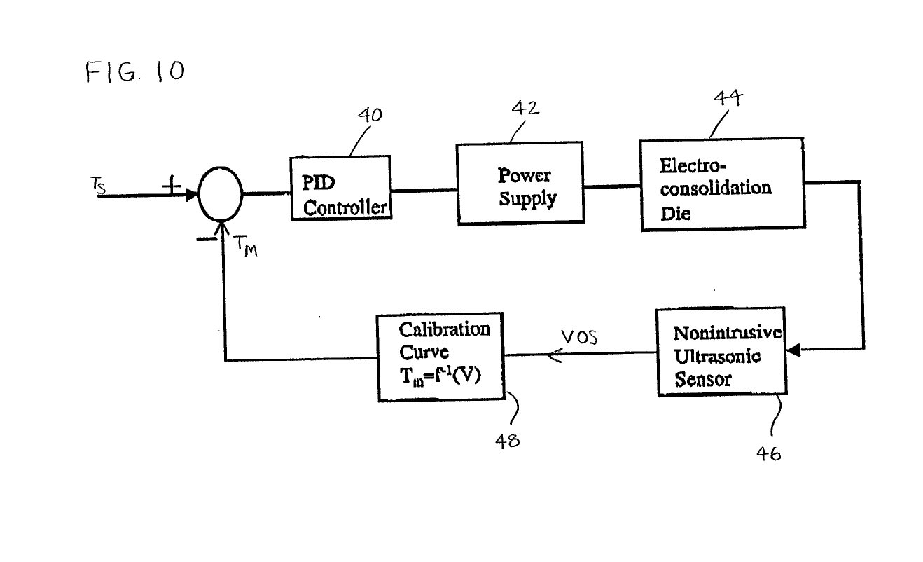

V=V₀−0.0008 T+0.0001 T²,

where V is the velocity of sound in m/s, V₀ is the initial velocity at the ambient temperature, and T is the temperature in Celsius. Knowing V₀ and V from the ultrasonic velocity measurements in the bed, temperature T vs. time was calculated and plotted in FIG. 9, along with the thermocouple readings. To verify the consistency of prediction, the predicted temperatures for the final two tests were plotted against the readings of a thermocouple located at the same position in the ram. Considering the difficulty of maintaining identical heating trajectories between two tests, the reproducibility of data is very good.

Once the bed temperature is determined, as set forth above, this information may be utilized in a control system to automatically control the amount of current input to the die. With reference to FIG. 10, there is seen a block diagram of a single-loop feedback control system for control of the temperature in an Electroconsolidation die. As described above, the temperature of the graphite bed pressure transmitting medium is determined based on the velocity of sound through the bed (as fitted to the quadratic equation whose constants are determined by calibration), and this value is then used in the feed-back loop of the temperature control system.

Turning again to FIG. 10, a temperature setting Tₛ is input through a “PID” (proportional, integral and derivative) controller 40. A control signal is sent to the power supply to direct a predetermined amount of current to the Electroconsolidation die 44. The temperature of the bed is then determined by the measurement of the velocity of sound (VOS) between the transducers 46, the velocity of sound being converted to a measured temperature Tₘ for the bed (based upon fitting the velocity to the calibration curve 48). The measured temperature Tₘ is then compared to the set temperature Tₛ. If the measured temperature is less than the set temperature, the PID controller 40 will cause the power supply 42 to increase the current to the die 44. Conversely, if the measured temperature is greater than the set temperature, the controller 40 will cause the power supply 42 to reduce the current to the die 44. Thus, the process temperature can be controlled to follow the desired heating trajectory for the proper sintering of materials placed in the bed.

Thus, a novel method and apparatus have been provided for use in Electroconsolidation methods and devices. While the invention has been described in conjunction with Electroconsolidation process, the ultrasonic sensor with suitable modification can be used in various other applications that deal with high temperatures and hostile environments. Some of the direct extensions of this idea would include diagnostic sensors for sintering of parts in powder metallurgy and hot pressing. Because the velocity of sound in a solid graphite material is found to increase with temperature, a graphite rod with suitable coating for protection from oxidation can be used as a waveguide sensor to measure temperature in high-temperature environments. Another extension of this concept is to use nonreacting powder materials as a coupling medium for ultrasonic interrogation of materials at high temperatures, e.g., plasma sintering.

1. In an Electroconsolidation apparatus having a die cylinder, first and second hydraulically-actuated, conductive rams slidably received in opposite ends of the die cylinder; first and second electrical leads in conductive contact with the first and second rams, respectively, the electrical leads being attached to a source of electrical power; and an electrically-conductive, pressure-transmitting medium disposed within the cylinder between the rams; the improvement comprising:
an apparatus for measuring the temperature within the die including a transmitting transducer associated with one of the first and second rams;
a receiving transducer associated with the other of the first and second rams, the transmitting transducer and the receiving transducer being spaced apart a distance within a predetermined range;
a signal generator associated with the transmitting transducer for creating a tone that is transmitted from the transmitting transducer to the receiving transducer;
whereby the temperature of the electrically-conductive, pressure-transmitting medium is calculated by measuring the time of flight of a tone created by the signal generator between the transmitting transducer and the receiving transducer.

2. The apparatus of claim 1 wherein the improvement further comprises a water-cooled electrical contact interposed between each of the first and second electrical leads and its associated ram, each of the transmitting transducer and receiving transducer being located within its water-cooled contact.

3. The apparatus of claim 1 further comprising a control circuit for controlling the amount of electrical power directed to the conductive rams through the electrical leads.

4. The apparatus of claim 3 wherein the control circuit comprises a single-loop feedback that compares an input temperature to the calculated temperature.

5. The apparatus of claim 4 further comprising a controller that adjusts the amount of electrical power directed to the conductive rams based upon a comparison of the input temperature to the calculated temperature.

6. A method for determining the temperature within an Electroconsolidation apparatus having a die cylinder, first and second hydraulically-actuated, conductive rams slidably received in opposite ends of the die cylinder; first and second electrical leads in conductive contact with the first and second rams, respectively, the electrical leads being attached to a source of electrical power; and an electrically-conductive, pressure-transmitting medium disposed within the cylinder between the rams; the method comprising:
providing a transmitting transducer associated with one of the first and second rams;
providing a receiving transducer associated with the other of the first and second rams, the transmitting transducer and the receiving transducer being spaced apart a distance within a predetermined range;
providing a signal generator associated with the transmitting transducer;
creating a tone that is transmitted from the transmitting transducer to the receiving transducer;
measuring the time of flight of the tone created by the signal generator between the transmitting transducer and the receiving transducer;
calculating the velocity of sound between the transmitting transducer and receiving transducer by dividing the distance between the transducers by the time of flight; and
calculating the temperature of the electrically-conductive, pressure transmitting medium.

7. The method of claim 6 further comprising providing a water-cooled electrical contact interposed between each of the first and second electrical leads and its associated ram, each of the transmitting transducer and receiving transducer being located within its water-cooled contact.

8. An apparatus for determining the temperature of within a medium comprising:
a transmitting transducer located exteriorly of the medium on one side thereof;
a receiving transducer located exteriorly of the medium on a side opposite to that on which the transmitting transducer is located;
a signal generator associated with the transmitting transducer for creating a tone that is transmitted from the transmitting transducer to the receiving transducer;
whereby the temperature of the medium is calculated by measuring the time of flight of a tone created by the signal generator between the transmitting transducer and the receiving transducer.
